(19) United States
(12) Patent Application Publication
(10) Pub. No.: US 2025/0306869 A1
(43) Pub. Date: Oct. 2, 2025

(54) GENERATING AI-BASED COLLABORATION METHOD AND SYSTEM

(71) Applicant: SAMSUNG SDS CO., LTD., Seoul (KR)

(72) Inventors: In Pyo KIM, Seoul (KR); Young Hyun CHOI, Seoul (KR); Ji Yeon LEE, Seoul (KR); Bo Young PARK, Seoul (KR)

(73) Assignee: SAMSUNG SDS CO., LTD., Seoul (KR)

(21) Appl. No.: 19/077,769

(22) Filed: Mar. 12, 2025

(30) Foreign Application Priority Data
Mar. 26, 2024 (KR) 10-2024-0041058
May 29, 2024 (KR) 10-2024-0070145

(51) Int. Cl. G06F 8/38; G06F 8/35

(52) U.S. Cl. CPC G06F 8/38; G06F 8/35

(57) ABSTRACT

Provided is a method performed by at least one computing device. The method comprises receiving information on a change target screen and information on a selected design template from a user terminal, classifying design elements that constitute the change target screen into a first design element that is common with design elements that constitute the design template and a second design element that is not common with the design elements that constitute the design template, changing a code of the first design element according to a preset code change rule, generating a new code for a new design element corresponding to the second design element, the new design element reflecting a rule of the design template, generating an integrated code that integrates the changed code for the first design element and the new code for the second design element and providing a change target screen whose design is changed according to the integrated code to the user terminal.

### CROSS-REFERENCE TO RELATED APPLICATION

This application claims priority from Korean Patent Application No. 10-2024-0041058 filed on Mar. 26, 2024, and Korean Patent Application No. 10-2024-0070145 filed on May 29, 2024, in the Korean Intellectual Property Office, and all the benefits accruing therefrom under 35 U.S.C. 119, the contents of which in its entirety are herein incorporated by reference.

### BACKGROUND

### Technical Field

The present disclosure relates to a method and system for changing a design using generative AI, and more particularly, to a method for changing a design of a web screen or an app screen according to a design template using a generative AI model and a system to which the method is applied.

### Description of the Related Art

In general, in order to improve a design of a web screen or an app screen that generally provides online services, not only does it require the investment of specialized personnel and take a long time, but there is also the problem that the results differ depending on the worker even if the task is performed according to the same reference.

For example, in the existing work process for improving screen design, the process of selecting a screen to be improved, researching design references on the web, selecting a direction for design improvement, modifying each element within the screen to be improved, and then checking and modifying the final result is repeated.

Accordingly, there is a need for a technology that allows anyone to easily change the screen design in the intended direction and quickly check the changed design, thereby producing consistent results.

### RELATED ART DOCUMENT

### Patent Document

Korean Patent Laid-Open Publication No. 10-2024-0001306 (published on Jan. 3, 2024)

### SUMMARY

Aspects of the present disclosure provide a method and system capable of dramatically reducing the number of iterative tasks for changing a screen design.

Aspects of the present disclosure also provide a method and system that may accurately reflect a user's design intention by providing various design templates suitable for a direction of design improvement intended by a user.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

According to some embodiments of the present disclosure, since the screen design may be changed and the changed design may be easily checked through simple manipulations, the usability and convenience of the user may be effectively improved.

Further, according to some embodiments, by applying different change rules to the design elements that constitute the screen according to the characteristics, efficiency in terms of computational volume and speed may be improved.

Effects according to the technical idea of the present disclosure are not limited to the effects mentioned above, and other effects that are not mentioned may be obviously understood by those skilled in the art from the following description.

According to an aspect of the present disclosure, there is provided method for changing a design using generative AI, performed by one or more computing devices. The method may comprise receiving information on a change target screen and information on a selected design template from a user terminal, classifying design elements that constitute the change target screen into a first design element that is common with design elements that constitute the design template and a second design element that is not common with the design elements that constitute the design template, changing a code of the first design element according to a preset code change rule, generating a new code for a new design element corresponding to the second design element, the new design element reflecting a rule of the design template, generating an integrated code that integrates the changed code for the first design element and the new code for the second design element and providing a change target screen whose design is changed according to the integrated code to the user terminal.

In some embodiments, the change target screen may include one or more screens.

In some embodiments, the receiving of the information may include receiving a prompt related to a design change for the change target screen, generating one or more design keywords based on the prompt and generating one or more recommended design templates corresponding to a design keyword selected from the one or more design keywords.

In some embodiments, the classifying of the design elements that constitute the change target screen may include extracting the design elements that constitute the change target screen, converting the design elements into corresponding codes and comparing the codes of the design elements with codes of the design elements that constitute the design template.

In some embodiments, the converting of the design elements into the corresponding codes may includes determining whether the design element is converted into the code and converting design elements determined to be converted into codes into corresponding codes and excluding design elements that are determined not to be converted into codes, as a result of the determination.

In some embodiments, the changing of the code of the first design element may include: comparing a rule of the first design element with a rule of a target design element of the design template corresponding to the first design element, changing a code value of the first design element to a code value of the target design element when the rules are identical as the result of the comparison and generating a new rule for the first design element corresponding to the rule of the target design element when the rules are not identical as the result of the comparison.

In some embodiments, the generating of the new rule for the first design element may include adding a detailed element that is included only in the rule of the target design element to the rule of the first design element.

In some embodiments, the generating of the new rule for the first design element may include deleting a detailed element that is included only in the rule of the first design element from the rule of the first design element.

In some embodiments, the method may further comprise receiving a request for modification of some of design elements that constitute the changed change target screen from the user terminal and providing a change target screen with some of the design elements modified based on the request for modification to the user terminal.

In some embodiments, the receiving of the request for modification may include providing a user interface for inputting the request for modification to the user terminal.

According to another aspect of the present disclosure, there is provided a system. The system may comprise one or more processors and a memory configured to store one or more computer programs executed by the one or more processors, wherein the one or more computer programs may include instructions for: an operation of receiving information on a change target screen and information on a selected design template from a user terminal, an operation of classifying design elements that constitute the change target screen into a first design element that is common with design elements that constitute the design template and a second design element that is not common with the design elements that constitute the design template, an operation of changing a code of the first design element according to a preset code change rule, an operation of generating a new code for a new design element corresponding to the second design element, the new design element reflecting a rule of the design template, an operation of generating an integrated code that integrates the changed code for the first design element and the new code for the second design element and an operation of providing a change target screen whose design is changed according to the integrated code to the user terminal.

In some embodiments, the change target screen may include one or more screens.

In some embodiments, the operation of receiving the information may include: an operation of receiving a prompt related to a design change for the change target screen, an operation of generating one or more design keywords based on the prompt and an operation of generating one or more recommended design templates corresponding to a design keyword selected from the one or more design keywords.

In some embodiments, the operation of classifying the design elements that constitute the change target screen may include: an operation of extracting the design elements that constitute the change target screen, an operation of converting the design elements into corresponding codes and an operation of comparing the codes of the design elements with codes of the design elements that constitute the design template.

In some embodiments, the operation of converting the design elements into the corresponding codes may include: an operation of determining whether the design element is converted into the code and an operation of converting design elements determined to be converted into codes into corresponding codes and excluding design elements that are determined not to be converted into codes, as a result of the determination.

In some embodiments, the operation of changing the code of the first design element may include: an operation of comparing a rule of the first design element with a rule of a target design element of the design template corresponding to the first design element, an operation of changing a code value of the first design element to a code value of the target design element when the rules are identical as the result of the comparison and an operation of generating a new rule for the first design element corresponding to the rule of the target design element when the rules are not identical as the result of the comparison.

In some embodiments, the operation of generating the new rule for the first design element may include an operation of adding a detailed element that is included only in the rule of the target design element to the rule of the first design element.

In some embodiments, the operation of generating the new rule for the first design element may include an operation of deleting a detailed element that is included only in the rule of the first design element from the rule of the first design element.

In some embodiments, the one or more computer programs may further include instructions for: an operation of receiving a request for modification of some of the design elements that constitute the changed change target screen from the user terminal an an operation of providing a change target screen with some of the design elements modified based on the request for modification to the user terminal.

In some embodiments, the operation of receiving the request for modification includes an operation of providing a user interface for inputting the request for modification to the user terminal.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is an exemplary diagram of the overall configuration of a generative AI-based collaborative system according to some embodiments of the present disclosure;

FIG. 2 is a flowchart illustrating a method for changing a design using generative AI according to some embodiments of the present disclosure;

FIG. 3 is a diagram for describing a detailed operation of step S100 illustrated in FIG. 2;

FIG. 4 is an exemplary diagram for describing a first design element and a second design element illustrated in FIG. 2;

FIG. 5 is a diagram for describing a detailed operation of step S300 illustrated in FIG. 2;

FIGS. 6 to 10 are exemplary diagrams of screens provided to a user terminal during a process of changing a design using generative AI according to an embodiment of the present disclosure; and

FIG. 11 is a block diagram illustrating a hardware configuration of a computing system for performing the method for changing the design using the generative AI according to some embodiments of the present disclosure.

### DETAILED DESCRIPTION OF THE EMBODIMENTS

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Hereinafter, embodiments of the present disclosure will be described with reference to the attached drawings.

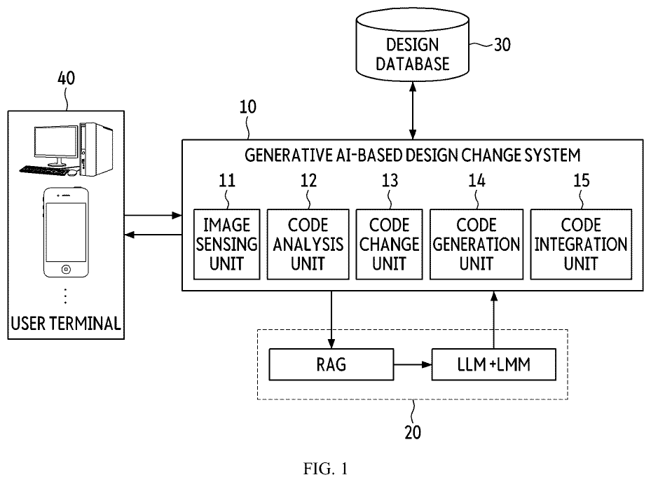

FIG. 1 is an exemplary diagram of the overall configuration of a generative AI-based collaborative system according to some embodiments of the present disclosure.

As illustrated in FIG. 1, a generative AI-based design change system 10 according to some embodiments of the present disclosure may implement a method for changing a design using generative AI according to some embodiments of the present disclosure through interaction with a generative AI model 20, a design database 30, and a user terminal 40.

According to an embodiment of the present disclosure, the generative AI-based design change system 10 may apply a design template to a change target screen based on a prompt input through the user terminal 40 and provide the change target screen with a changed (applied) design to the user terminal 40.

Specifically, a user may input a prompt (user request) to be transmitted to the generative AI-based design change system 10 through the user terminal 40, i.e., through a user interface provided by the generative AI-based design change system 10. The user interface may include both a graphical user interface such as a dialog box and a search box that requests a user query to a generative AI-based design change service, and an application interface such as Rest API. Here, the prompt may be in various forms such as text, voice, image, video, etc.

The generative AI-based design change system 10 may provide a response according to the prompt in conjunction with the generative AI model 20. For example, the generative AI-based design change system 10 may generate one or more design keywords based on the prompt, and may generate one or more recommended design templates corresponding to the selected design keywords and provide the recommended design templates to the user terminal 40. In addition, the generative AI-based design change system 10 may provide a change target screen changed according to a design template to the user terminal 40. Here, the generative AI model 20 may be learned through information stored in the design database 30. In addition, the generative AI model 20 may include a Large Language Model (LLM) with natural language (text) understanding and generation capabilities, and a vision language model (or Large Multimodal Model (LMM)) further with image understanding capabilities, and may also include understanding capabilities for other modals. The generative AI model may be either a self-developed model or a model provided externally. The generative model may also be named, in some cases, as ‘Language Model (LM)’, ‘Large Language Model (LLM)’, ‘Generative Language/Deep Learning Model’, or ‘Generative Model’.

Hereinafter, the configuration and function of the generative AI-based design change system 10 according to an embodiment of the present disclosure are described in more detail.

The generative AI-based design change system 10 according to an embodiment of the present disclosure may include image sensing unit 11, a code analysis unit 12, a code change unit 13, a code generation unit 14, and a code integration unit 15. However, since the components illustrated in FIG. 1 do not reflect all the functions of the generative AI-based design change system 10, and are not essential, the generative AI-based design change system 10 may include more or fewer components than the illustrated components.

In addition, the components of the generative AI-based design change system 10 illustrated in FIG. 1 represent functional elements that are functionally separated, and may also be implemented in the form in which a plurality of components may be integrated with each other in an actual physical environment, and may also be implemented in the form in which a specific component is separated into a plurality of sub-components.

The image sensing unit 11 may perform a function of extracting design elements that constitute the change target screen. Specifically, an image constituting the change target screen may be extracted from the image sensing unit 11, and the design elements may be extracted from the change target screen through a process of classifying the extracted image for each design element using an AI model. In this case, since the conventional technology may be applied to the technology of preprocessing and analyzing the image of the change target screen and classifying the image for each design element, a detailed description thereof will be omitted.

Here, design elements may include a color, a component, a font, an image, a layout, a shape, etc. The color element may include a primary color, a secondary color, a third color, a point color, a BG color, etc. The component element represents functional elements used on the screen, and may include a button, a checkbox, a dropdown, a pagination, a progress bar, a radio button, a tab, etc. The font element may include a font type, a font size, a font color, etc. The image element may include a real-world image and an icon image. The layout element may include navigation, a top bar, and other elements. The shape element may include a rounded shape, a diagonal shape, and an angular shape.

In an embodiment, the image sensing unit 11 may convert the extracted design elements into code. Specifically, the image sensing unit 11 may determine whether each extracted design element may be converted into code, may code the design element (e.g., code the design element into HTML, CSS, or Java script) if it is determined that the design element may be converted into code, and may process (exclude) the image element as a simple image if it is determined that the design element may not be converted into code.

The code analysis unit 12 may perform a function of comparing a code of the design elements constituting the change target screen with a code of the design elements constituting a design template and classifying a first design element representing common design elements and a second design element representing non-common design elements. A detailed description thereof will be provided later. The design elements classified as the first design element in the code analysis unit 12 may be transferred to the code change unit 13 described later, and the design elements classified as the second design element may be transferred to the code generation unit 14 described later.

The code change unit 13 may perform a function of changing the code of the first design element according to a preset code change rule. Here, the preset code change rule may mean changing the rule or code value of the first design element according to the rule or code value of the design element (target design element) of the corresponding design template. Specifically, the code change unit 13 may determine whether the rules are identical by comparing detailed elements that constitute the rules of the first design element and the target design element using the AI model, and may perform different processing for elements with the identical rule and elements with different rules. More specifically, when the rules are identical, the code value of the first design element may be changed according to the target design element, and when the rules are not identical, the rule of the first design element may be newly generated to correspond to the rule of the target design element using a generative AI model.

The code generation unit 14 may perform a function of generating a new code for a new design element corresponding to the second design element using the generative AI model. In this case, the rule of the design template may be reflected to the new design element.

The code integration unit 15 may perform a function of generating an integrated code in which the changed code for the first design element and the new code for the second design element are integrated. In addition, the code integration unit 15 may perform a function of providing a change target screen whose design is changed according to the integrated code to the user terminal. The user may immediately check the changed design through the user terminal and perform modification work on part or all of the changed design.

Although FIG. 1 illustrates that the components of the generative AI-based design change system 10 perform a linked operation with one generative AI model 20, the present disclosure is not necessarily limited to such an example. That is, the code change unit 13, the code generation unit 14, and the code integration unit 15 may perform some of the design change processes using different generative AI models corresponding to each module.

So far, the configuration and operation of the generative AI-based design change system 10 according to some embodiments of the present disclosure have been described with reference to FIG. 1. The embodiments described above may be understood in more detail with reference to other embodiments described later. In addition, the technical ideas that may be understood through the embodiments described above may be applied to other embodiments described later even if not specifically stated otherwise.

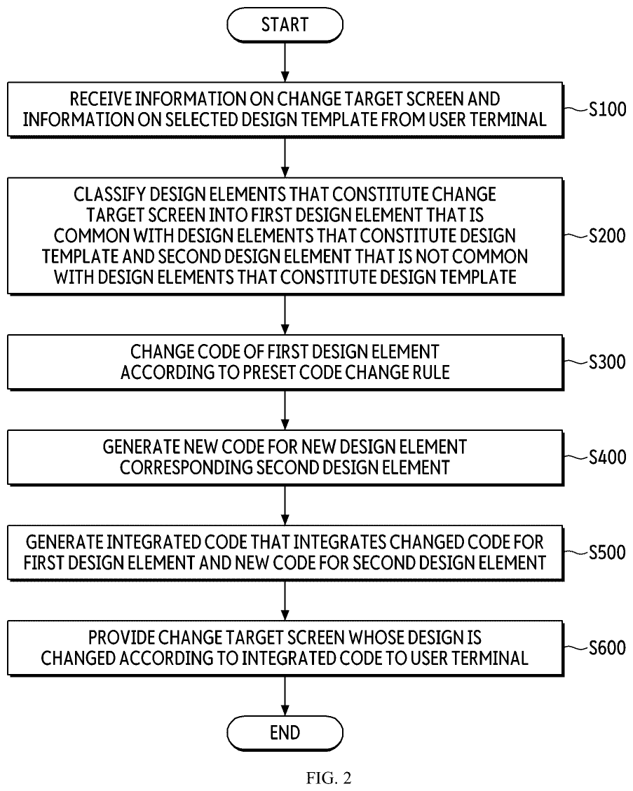

Hereinafter, a method for changing a design using generative AI according to another embodiment of the present disclosure will be described with reference to FIGS. 2 to 10. It may be understood that the steps described in the following flowcharts are performed by the generative AI-based design change system 10 described with reference to FIG. 1 unless otherwise stated. However, for convenience of explanation, the description of the operation subject of each step may also be omitted.

FIG. 2 is a flowchart illustrating a method for changing a design using generative AI according to some embodiments of the present disclosure. However, this is only a preferred embodiment for achieving the object of the present disclosure, and some steps may also be added or deleted as needed.

As illustrated in FIG. 2, a method for changing a design using generative AI according to an embodiment of the present disclosure may start from step S100 of receiving information on a change target screen and information on a selected design template from a user terminal. Specifically, the user may select a change target screen that is a target of a design change and a design template of a design that needs to be changed through the user terminal, and information on the selected change target screen and design template may be received. Here, the change target screen may include a single screen or one or more screens as an entire screen of a web or app related to a specific project or service.

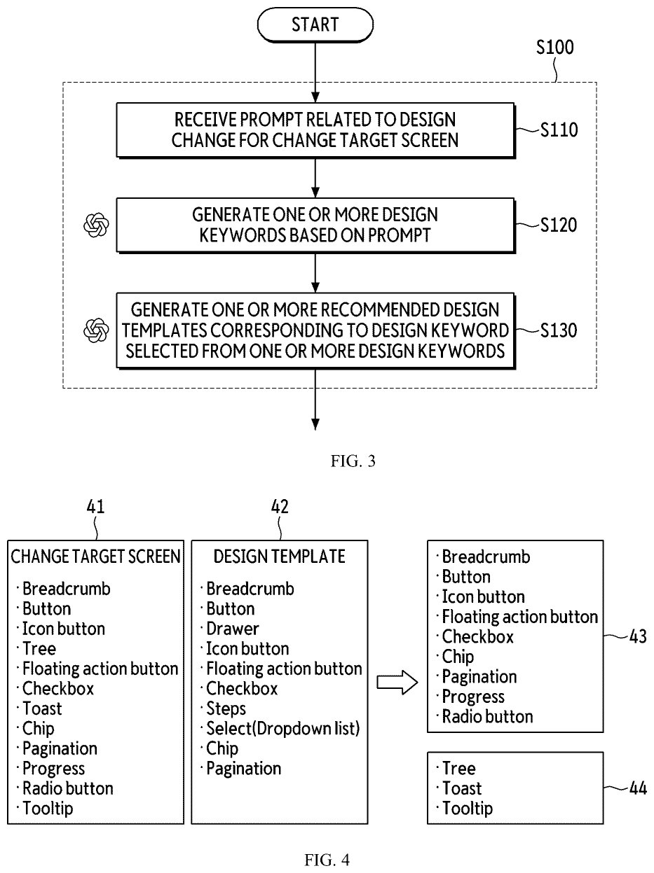

In an embodiment, the selected design template may be any one of one or more recommended design templates. This will be described with reference to FIG. 3.

FIG. 3 is a diagram for describing a detailed operation of step S100 illustrated in FIG. 2.

Referring to FIG. 3, first, a prompt related to a design change for the change target screen input through the user terminal may be received (step S110). The prompt may include information on a service related to the change target screen, information on a style or mood of the design to be changed, information on a direction of the design to be changed, etc. For example, the prompt may include requests for design improvements, such as “I want to update the design of Service A to a modern one.” and “Please generate design keywords that reflect current design trends.”

Next, in step S120, one or more design keywords may be generated based on the prompt. Specifically, the prompt may be input into the generative AI model, and the generative AI model may analyze the prompt and generate one or more design keywords that reflect current design trends and the direction of design improvement desired by the user based on the analyzed prompt. In this case, the generative AI model may be trained based on data of a plurality of design reference sites. In addition, when there is already registered design guide information (including basic guidelines and rules for design elements) related to the change target screen, the prompt may be expanded as the design guide information is reflected. Accordingly, the generative AI model may generate one or more design keywords by considering the design guide information.

Next, in step S130, one or more recommended design templates corresponding to a design keyword selected from among the one or more design keywords may be generated. Specifically, the user may select any one of the one or more design keywords through the user terminal, and the generative AI model may generate one or more recommended design templates corresponding to the selected design keyword. In this case, the recommended design template may be generated based on an existing design style of the change target screen. That is, the recommended design template may be created by reflecting the total number of screens of the current change target screen, the design elements that constituting the change target screen, and the design guide information registered in the change target screen. The user may check the one or more recommended design templates through the user terminal, and any one of the one or more recommended design templates may be selected as the design template for changing the design of the change target screen.

Referring again to FIG. 2, in step S200, the design elements that constitute the change target screen may be classified into a first design element that is common to the design elements that constitute the design template and a second design element that is not common to the design elements that constitute the design template. In the process of applying the design of the design template to the change target screen, design elements that are commonly included in the change target screen and the design template may be changed (applied) in a simple way by changing the rule or code value, and design elements that are not included in the design template need to follow a process of generating the corresponding design elements. Therefore, this classification is intended to separately handle the above-mentioned design elements.

In order to perform the classification operation, an operation may first be performed to extract the design elements that constitute the change target screen and to convert the extracted design elements into corresponding codes. Specifically, an image constituting the change target screen may be extracted from the image sensing unit 11, and the design elements may be extracted from the change target screen through a process of classifying the extracted image for each design element using an AI model. Here, design elements may include a color, a component, a font, an image, a layout, a shape, etc.

Next, the image sensing unit 11 may determine whether each extracted design element may be converted into code, may code the design element (e.g., code the design element into HTML, CSS, or Java script) if it is determined that the design element may be converted into code, and may process (exclude process) the image element as a simple image if it is determined that the design element may not be converted into code.

Next, the code analysis unit 12 may compare code information of the design templates with code information of the change target screen and classify a first design element representing common design elements and a second design element representing non-common design elements. In an embodiment, the design element that is a target of the operation of classifying the design elements into the first design element and the second design element may be the component. This is to increase efficiency in terms of computational volume and speed by targeting only the component that requires new generation, because the design change (application) of the elements (the color, the font, the image, the layout, the shape, etc.) except for the component among the design elements may be made in a simple way by changing the rule or code value.

Hereinafter, the meanings of the first design element and the second design element will be more clearly described with reference to FIG. 4.

FIG. 4 is an exemplary diagram for describing a first design element and a second design element.

As illustrated in FIG. 4, by comparing the components (Breadcrumb, Button, Icon button, Tree, etc.) 41 included in the change target screen and the components (Breadcrumb, Button, Drawer, Icon button, Floating action button, etc.) 42 included in the design template, common components may be classified as a first design element 43, and non-common components (i.e., components included only in the change target screen) may be classified as a second design element 44.

Next, referring again to FIG. 2, in step S300, the code of the first design element may be changed according to a preset code change rule. Here, the first design element may represent the design element excluding the components classified as the second design element in step S200. In addition, the preset code change rule may mean changing a rule or code value related to the change target screen to a rule or code value related to the design template.

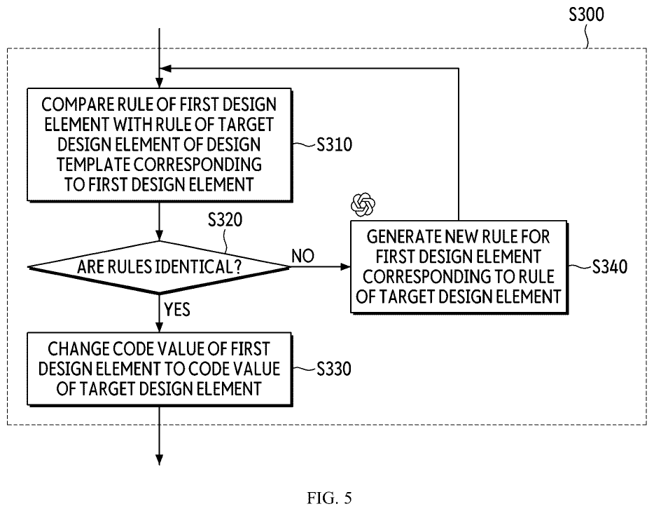

Hereinafter, a detailed description will be provided with reference to FIG. 5.

FIG. 5 is a diagram for describing a detailed operation of step S300 illustrated in FIG. 2.

As illustrated in FIG. 5, first, a rule of the first design element and a rule of a target design element of the design template corresponding to the first design element may be compared (S310). Here, the rule of the design element may mean a detailed element defined in relation to a particular design element. For example, when ‘primary color’, ‘secondary color’, and ‘third color’ are defined (set) in relation to the ‘color’ element, the ‘primary color’, the ‘secondary color’, and the ‘third color’ may be referred to as the rule of the ‘color’ element. As another example, ‘button’, ‘check box’, and ‘drop down’ defined in relation to the ‘component’ element may be referred to as the rule of the ‘component’ element. As another example, ‘font type’, ‘font size’, and ‘font color’ defined in relation to the ‘font’ element may be referred to as the rule of the ‘font’ element.

Next, in step S320, it may be determined whether the rules of the design elements are identical. Here, the rules of the design elements being identical may mean that detailed elements defined in relation to a particular design element are identical. For example, when ‘Main Title’, ‘Subtitle’, and ‘Body’ are defined in relation to the ‘Font’ element of the change target screen, and ‘Main Title’, ‘Intermediate title’, ‘Subtitle’, and ‘Body’ are defined in relation to the ‘Font’ element of the design template, it may be determined that the rule of the ‘font’ element of the change target screen are not identical to the rule of the ‘font’ element of the design template.

Next, if the rules are determined to be identical (Yes) as a result of determining whether the rules are identical, the code value of the first design element may be changed to the code value of the target design element (S330).

On the other hand, if the rules are determined to be not identical (No), a new rule for the first design element that corresponds to the rule of the target design element may be generated. In an embodiment, the new rule for the first design element may be generated by adding or deleting some of the detailed elements that constitute the rule for the first design element. Specifically, when comparing the detailed elements that constitute the rule of the first design element with the detailed elements that constitute the rule of the target design element, if there are detailed elements that are included only in the rule of the target design element, the detailed elements may be added to the rule of the first design element, and if there are detailed elements that are included only in the rule of the first design element, the detailed elements may be deleted from the rule of the first design element.

In addition, when the new rule for the first design element is generated, the comparison operation with the rule of the target design element is performed again, so that the code value of the first design element may be changed to the code value of the target design element, and finally, the rule and code value for the first design element will be changed to be the same as those for the target design element.

Next, referring back to FIG. 2, in step S400, a new code for a new design element corresponding to the second design element may be generated. This is because in order to apply a style of the design template to the second design element, a new design element corresponding to the second design element that reflects the style of the design template needs to first be generated. As described above, the second design element may represent the components that are included only in the change target screen, but are not present in the design template.

Specifically, the code generation unit 14 may generate a new code that reflects the rule of the design template and GUI trends using the generative AI model. In this case, it may be determined whether the new code conforms to the rule of the design element associated with the design template. Accordingly, a new design element that reflects the rule of the design template may be generated.

Next, in step S500, an integrated code in which the changed code for the first design element and the new code for the second design element are integrated may be generated. Specifically, the code changed in the code change unit 13 and the new code generated in the code generation unit 14 may be integrated in the code integration unit 15, and a new code may be generated during this process. For example, when considering the arrangement, configuration, etc. of each design element, if the changed code and the new code may not be integrated through a simple combination, the integrated code that integrates the changed code for the first design element and the new code for the second design element may be generated through a method of generating the new code to integrate the changed code with the new code using the generative AI model.

Next, in step S600, a change target screen whose design has been changed according to the integrated code may be provided to the user terminal. The user may visually check the changed design of the change target screen through the user terminal. In an embodiment, step S600 of providing the changed change target screen to the user terminal may further include a step of receiving a request for modification of some of the design elements constituting the changed change target screen from the user terminal and a step of providing a change target screen with some of the design elements modified based on the request for modification to the user terminal. That is, if some or all of the design elements that constitute the change target screen to which the style of the design template is applied according to the operation need to be modified, the user may input a request for modification for the design elements that are being modified. For example, a user interface that allows the user to change the properties of each design element, such as size and color may be provided on the user terminal, and the request for modification for the design elements to be modified may be input through a method of inputting modifications through the user interface. As another example, the user may also input the request for modification for the design elements to be modified through a method of inputting a request for modification, such as ‘Change the color of element A’, to an area where the prompt is input.

In this way, according to the present embodiment, with just a simple operation of selecting the change target screen and the design template, the style of the design template may be automatically applied and reflected to the change target screen. Accordingly, since the design of the change target screen may be easily changed without the assistance of specialized personnel for design improvement, the usability and convenience of user may be effectively improved.

Hereinafter, a method for changing a design using generative AI according to the present embodiment will be described in more detail with reference to specific embodiments.

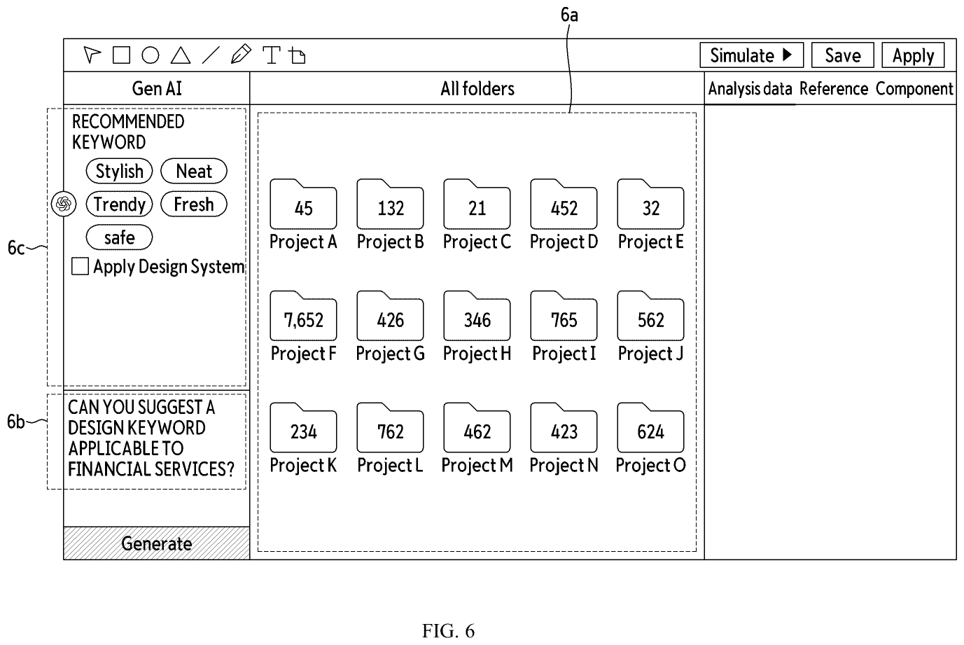

FIGS. 6 to 10 are exemplary diagrams of screens provided to a user terminal during a process of changing a design using generative AI according to an embodiment of the present disclosure. With reference to FIGS. 6 to 10, the process of changing the design described with reference to FIGS. 2 to 5 will be more clearly understood.

First, as illustrated in FIG. 6, the screen provided to the user terminal may include a board area 6a and communication areas 6b and 6c. The board area 6a may display information on the change target screen, information on the results of the design change, etc. For example, as illustrated in FIG. 6, the board area 6a may display design outputs for each project, i.e., information on a plurality of screens related to the project. In addition, the communication areas 6b and 6c may include an area 6b where the user may input a prompt and an area 6c where a response to the prompt input by the user may be displayed.

In order to perform a design change according to the present embodiment, the user may input a prompt (“Can you suggest a design keyword applicable to financial services?”) related to the design change for the change target screen into the communication area 6b, and one or more design keywords may be displayed based on the prompt. For example, as illustrated, “Stylish”, “Neat”, “Trendy”, “Fresh”, and “safe” may be displayed and provided in the form of tabs as design keywords.

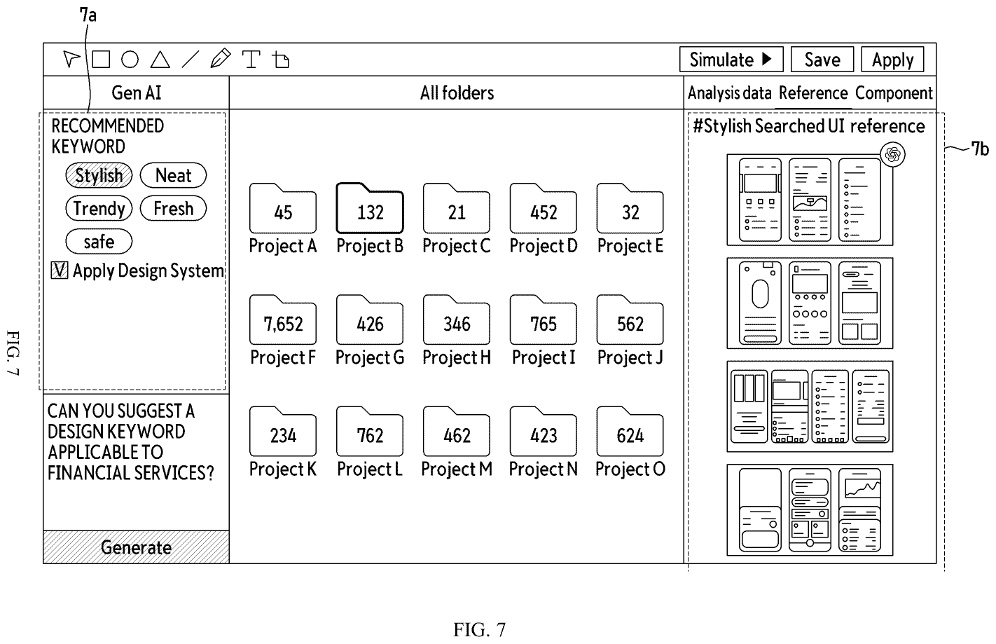

Next, as illustrated in FIG. 7, when any one of the generated one or more design keywords is selected, the selected design keyword may be shaded to indicate that it has been selected 7a, and one or more design templates corresponding to the selected design keyword (“Stylish”) may be displayed in another area 7b.

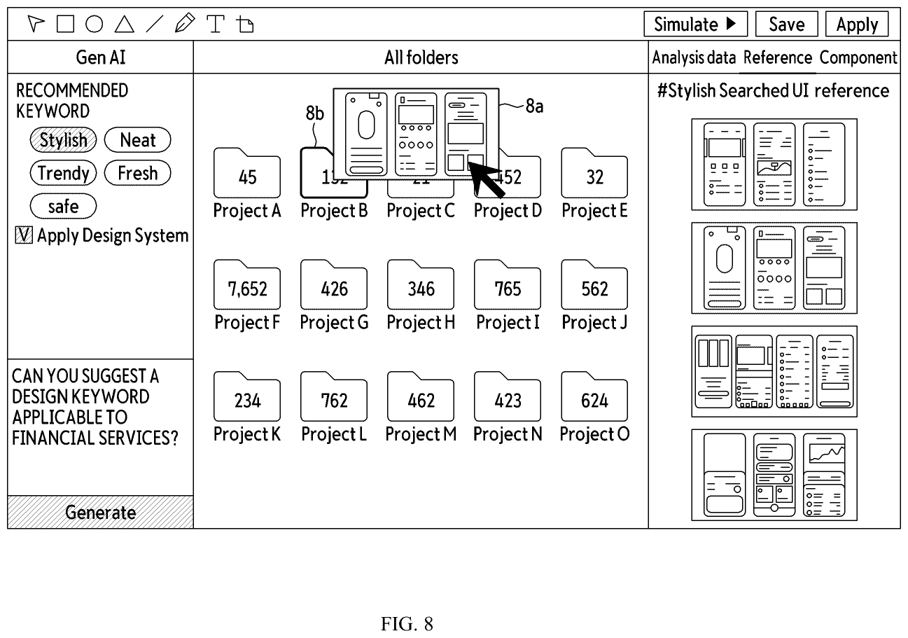

Next, as illustrated in FIG. 8, by selecting any one of the one or more design templates, and then dragging and dropping the selected design template 8a to a project folder (i.e., the change target screen) 8b to be applied, a design change according to the present embodiment may be initiated.

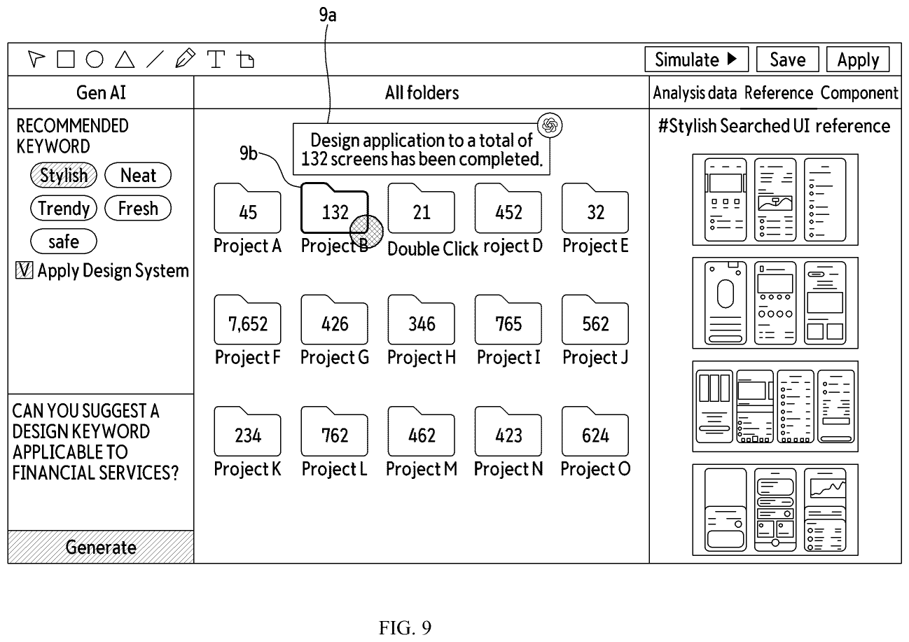

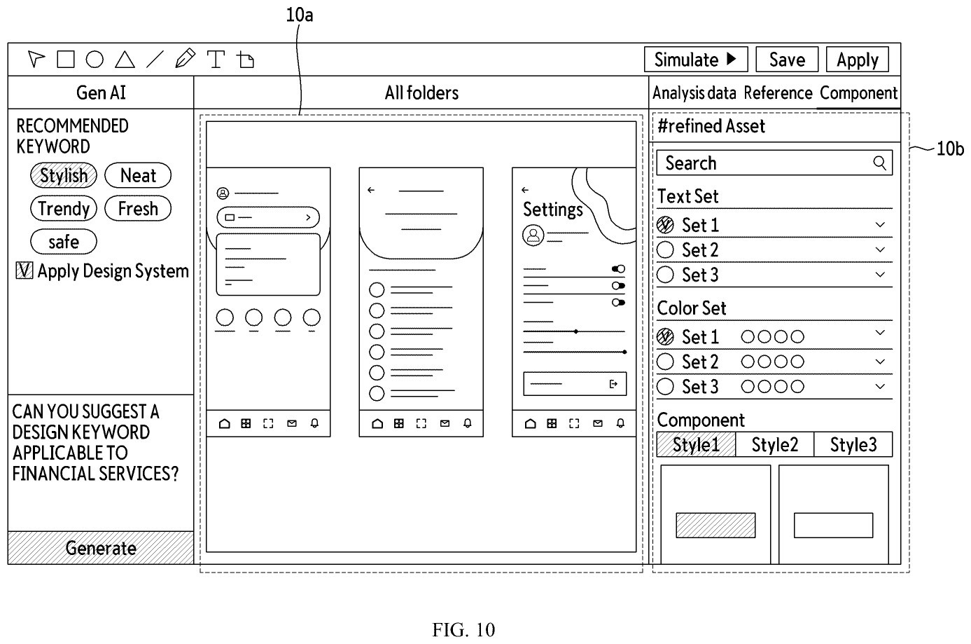

Next, when the design template selected according to the operation according to the present embodiment is applied to the change target screen (i.e., when the design of the change target screen is changed according to the integrated code), a message 9a indicating that the design change has been completed may be displayed as illustrated in FIG. 9. When the user selects the project folder 9b, a full screen 10a with the changed design may be provided, as illustrated in FIG. 10, and the user may check each screen and modify or change some design elements (10b).

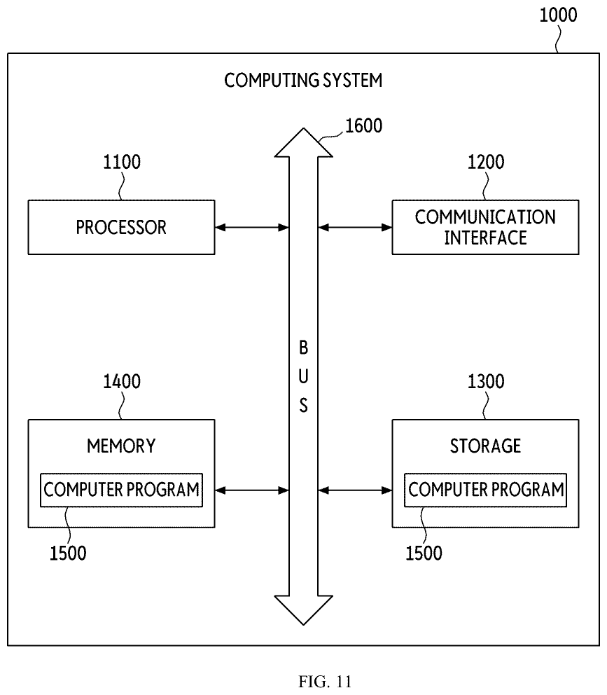

FIG. 11 is a block diagram illustrating a hardware configuration of a computing system for performing the method for changing the design using the generative AI according to some embodiments of the present disclosure.

Referring to FIG. 11, a computing system 1000 may include one or more processors 1100, a system bus 1600, a communication interface 1200, a memory 1400 for loading a computer program 1500 executed by the processor 1100, and a storage 1300 for storing the computer program 1500. However, only the components related to the embodiments of the present disclosure are illustrated in FIG. 11. Therefore, those skilled in the art to which the present disclosure pertains may see that other general-purpose components other than the components illustrated in FIG. 11 may be further included. That is, the computing system 1000 may further include various components other than the components illustrated in FIG. 11. In addition, in some cases, the computing system 1000 may also be configured in a form in which some of the components illustrated in FIG. 11 are omitted. Hereinafter, each component of the computing system 1000 will be described.

The processor 1100 may control an overall operation of each component of the computing system 1000. The processor 1100 may be configured to include at least one of a central processing unit (CPU), a micro processor unit (MPU), a micro controller unit (MCU), a graphic processing unit (GPU), or any type of processor well known in the art. In addition, the processor 1100 may perform a calculation on at least one application or program for executing the specific steps/operations/methods. The computing device 1000 may include one or more processors.

Next, the memory 1400 stores various data, commands, and/or information. The memory 1400 may load the computer program 1500 from the storage 1300 to execute the operations/methods according to the embodiments of the present disclosure. The memory 1400 may be implemented as a volatile memory such as RAM, but the technical scope of the present disclosure is not limited thereto.

Next, the bus 1600 may provide a communications function between the components of the computing system 1000. The bus 1600 may be implemented as various types of buses, such as an address bus, a data bus, and a control bus.

Next, the communication interface 1200 supports wired/wireless Internet communications of the computing system 1000. In addition, the communication interface 1200 may also support various communication methods other than Internet communications. To this end, the communication interface 1200 may include a communication module well known in the art of the present disclosure.

Next, the storage 1300 may non-temporarily store one or more computer programs 1500. The storage 1300 may include a non-volatile memory such as a read only memory (ROM), an erasable programmable ROM (EPROM), an electrically erasable programmable ROM (EEPROM), a flash memory, or the like, a hard disk, a removable disk, or any form of computer-readable recording medium well known in the art to which the present disclosure pertains.

Next, the computer program 1500 may include one or more instructions that when loaded into the memory 1400, cause the processor 1100 to perform the specific steps/operations/methods. That is, the processor 1100 may perform the specific steps/operations/methods by executing the one or more instructions.

For example, the computer program 1500 may include instructions for an operation of receiving information on a change target screen and information on a selected design template from a user terminal, an operation of classifying design elements that constitute the change target screen into a first design element that is common with design elements that constitute the design template and a second design element that is not common with the design elements that constitute the design template, an operation of changing a code of the first design element according to a preset code change rule, an operation of generating a new code for a new design element corresponding to the second design element, the new design element reflecting a rule of the design template, an operation of generating an integrated code that integrates the changed code for the first design element and the new code for the second design element, and an operation of providing a change target screen whose design is changed according to the integrated code to the user terminal.

In some embodiments, the computing system 1000 illustrated in FIG. 11 may also refer to a virtual machine implemented based on cloud technology. For example, the computing system 1000 may be a virtual machine operating on one or more physical servers included in a server farm. In this case, at least some of the processor 1100, the memory 1400, and the storage 1300 illustrated in FIG. 11 may be virtual hardware, and the communication interface 1200 may also be implemented as a virtualized networking element such as a virtual switch.

Various embodiments of the present disclosure and effects according to the embodiments have been mentioned with reference to FIGS. 1 to 11. The effects according to the technical spirits of the present disclosure are not limited to the above-mentioned effects, and other effects not mentioned will be clearly understood by those skilled in the art from the following description.

Furthermore, although a plurality of components have been described as being combined into one or operated in combination in the above embodiments, the technical spirits of the present disclosure are not necessarily limited thereto. That is, all of the components may operate to be selectively combined in one or more within the purpose scope of the technical spirits of the present disclosure.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications can be made to the preferred embodiments without substantially departing from the principles of the present disclosure. Therefore, the disclosed preferred embodiments of the disclosure are used in a generic and descriptive sense only and not for purposes of limitation.

What is claimed is:

1. A method for changing a design using generative AI, performed by one or more computing devices, the method comprising:
receiving information on a change target screen and information on a selected design template from a user terminal;
classifying design elements that constitute the change target screen into a first design element that is common with design elements that constitute the design template and a second design element that is not common with the design elements that constitute the design template;
changing a code of the first design element according to a preset code change rule;
generating a new code for a new design element corresponding to the second design element, the new design element reflecting a rule of the design template;
generating an integrated code that integrates the changed code for the first design element and the new code for the second design element; and
providing a change target screen whose design is changed according to the integrated code to the user terminal.

2. The method of claim 1, wherein the change target screen includes one or more screens.

3. The method of claim 1, wherein the receiving of the information includes:
receiving a prompt related to a design change for the change target screen;
generating one or more design keywords based on the prompt; and
generating one or more recommended design templates corresponding to a design keyword selected from the one or more design keywords.

4. The method of claim 1, wherein the classifying of the design elements that constitute the change target screen includes:
extracting the design elements that constitute the change target screen;
converting the design elements into corresponding codes; and
comparing the codes of the design elements with codes of the design elements that constitute the design template.

5. The method of claim 4, wherein the converting of the design elements into the corresponding codes includes:
determining whether the design element is converted into the code; and
converting design elements determined to be converted into codes into corresponding codes and excluding design elements that are determined not to be converted into codes, as a result of the determination.

6. The method of claim 1, wherein the changing of the code of the first design element includes:
comparing a rule of the first design element with a rule of a target design element of the design template corresponding to the first design element;
changing a code value of the first design element to a code value of the target design element when the rules are identical as the result of the comparison; and
generating a new rule for the first design element corresponding to the rule of the target design element when the rules are not identical as the result of the comparison.

7. The method of claim 6, wherein the generating of the new rule for the first design element includes adding a detailed element that is included only in the rule of the target design element to the rule of the first design element.

8. The method of claim 6, wherein the generating of the new rule for the first design element includes deleting a detailed element that is included only in the rule of the first design element from the rule of the first design element.

9. The method of claim 1, further comprising:
receiving a request for modification of some of design elements that constitute the changed change target screen from the user terminal; and
providing a change target screen with some of the design elements modified based on the request for modification to the user terminal.

10. The method of claim 9, wherein the receiving of the request for modification includes providing a user interface for inputting the request for modification to the user terminal.

11. A generative AI-based design change system comprising:
one or more processors; and
a memory configured to store one or more computer programs executed by the one or more processors,
wherein the one or more computer programs include instructions for:
an operation of receiving information on a change target screen and information on a selected design template from a user terminal;
an operation of classifying design elements that constitute the change target screen into a first design element that is common with design elements that constitute the design template and a second design element that is not common with the design elements that constitute the design template;
an operation of changing a code of the first design element according to a preset code change rule;
an operation of generating a new code for a new design element corresponding to the second design element, the new design element reflecting a rule of the design template;
an operation of generating an integrated code that integrates the changed code for the first design element and the new code for the second design element; and
an operation of providing a change target screen whose design is changed according to the integrated code to the user terminal.

12. The generative AI-based design change system of claim 11, wherein the change target screen includes one or more screens.

13. The generative AI-based design change system of claim 11, wherein the operation of receiving the information includes:
an operation of receiving a prompt related to a design change for the change target screen;
an operation of generating one or more design keywords based on the prompt; and
an operation of generating one or more recommended design templates corresponding to a design keyword selected from the one or more design keywords.

14. The generative AI-based design change system of claim 11, wherein the operation of classifying the design elements that constitute the change target screen includes:
an operation of extracting the design elements that constitute the change target screen;
an operation of converting the design elements into corresponding codes; and
an operation of comparing the codes of the design elements with codes of the design elements that constitute the design template.

15. The generative AI-based design change system of claim 14, wherein the operation of converting the design elements into the corresponding codes includes:
an operation of determining whether the design element is converted into the code; and
an operation of converting design elements determined to be converted into codes into corresponding codes and excluding design elements that are determined not to be converted into codes, as a result of the determination.

16. The generative AI-based design change system of claim 11, wherein the operation of changing the code of the first design element includes:
an operation of comparing a rule of the first design element with a rule of a target design element of the design template corresponding to the first design element;
an operation of changing a code value of the first design element to a code value of the target design element when the rules are identical as the result of the comparison; and
an operation of generating a new rule for the first design element corresponding to the rule of the target design element when the rules are not identical as the result of the comparison.

17. The generative AI-based design change system of claim 16, wherein the operation of generating the new rule for the first design element includes an operation of adding a detailed element that is included only in the rule of the target design element to the rule of the first design element.

18. The generative AI-based design change system of claim 16, wherein the operation of generating the new rule for the first design element includes an operation of deleting a detailed element that is included only in the rule of the first design element from the rule of the first design element.

19. The generative AI-based design change system of claim 11, wherein the one or more computer programs further include instructions for:
an operation of receiving a request for modification of some of the design elements that constitute the changed change target screen from the user terminal; and
an operation of providing a change target screen with some of the design elements modified based on the request for modification to the user terminal.

20. The generative AI-based design change system of claim 19, wherein the operation of receiving the request for modification includes an operation of providing a user interface for inputting the request for modification to the user terminal.
